(19) United States
(12) Patent Application Publication
(10) Pub. No.: US 2018/0181399 A1
(43) Pub. Date: Jun. 28, 2018

(54) INFORMATION PROCESSING DEVICE, INFORMATION PROCESSING METHOD, AND STORAGE MEDIUM

(71) Applicant: NEC Corporation, Tokyo (JP)

(72) Inventor: Yuki TANNO, Tokyo (JP)

(73) Assignee: NEC Corporation, Tokyo (JP)

(21) Appl. No.: 15/838,477

(22) Filed: Dec. 12, 2017

(30) Foreign Application Priority Data
Dec. 28, 2016 (JP) 2016-255187

(51) Int. Cl. G06F 9/30; G06F 9/455; G06F 11/34

(52) U.S. Cl. CPC G06F 9/30145; G06F 9/45504; G06F 11/3612; G06F 11/348; G06F 8/4441

(57) ABSTRACT

An information processing device according to an example aspect of the invention includes a detection circuit a compilation execution circuit. A detection circuit is configured to detect an access to a storage by an instruction execution processor, the instruction execution processor retrieving an instruction different from a native code from the storage and executing the instruction after interpretation. A detection circuit is configured to detect an identifier of the instruction based on the detected access. A compilation execution circuit configured to compile the instruction specified by the detected identifier into one or more native codes and write the one or more native codes into the storage. In executing the instruction, when the instruction is already compiled, the instruction execution processor retrieves the one or more native codes from the storage, and executes the one or more native codes.

This application is based upon and claims the benefit of priority from Japanese Patent Application No. 2016-255187, filed on Dec. 28, 2016, the disclosure of which is incorporated herein in its entirety by reference.

### TECHNICAL FIELD

The present disclosure relates to processing for executing instructions that is performed by an information processing device.

### BACKGROUND ART

In computer systems, instructions (which are also referred to as “codes”) processed by a processor are based on a defined Instruction Set Architecture (ISA). When a computer performs emulation, in a case where an execution-target program is composed of instructions based on an ISA different from the ISA of a processor that processes the instructions, the program is not correctly executed unless compatibility exists between these ISAs. Thus, when the processor executes the program based on an ISA different from the ISA of the processor, it is necessary to convert the instructions of the program into instructions based on the ISA of the processor. Here, the instructions based on the ISA of the processor are also referred to as “native codes”.

There are mainly two kinds of strategies for converting instructions that are to be executed into native codes. One of the strategies is an interpreter strategy including converting instructions into one or more native codes one by one and executing the one or more native codes. The other one of the strategies is a compiler strategy including compiling a plurality of instructions at a time into a set of native codes and executing the set of native codes.

In the compiler strategy, the native codes can be optimized taking into consideration the context of instructions, and thus, throughput in relation to execution of the instructions is higher than in the interpreter strategy. In the compiler strategy, however, when a large number of instructions are simultaneously compiled, it takes a long time until the completion of such a compilation. The execution of the native codes is suspended during a compilation process, and thus, in a case where a time necessary to complete the compilation process is long, the throughput is lowered.

In each of Japanese Patent No. 4713820 (JP 4713820 B) and Japanese Unexamined Patent Application Publication No. 2013-61810 (JP 2013-61810 A), a technology for concurrently using the compilation process and the interpreter process is disclosed.

In the technology disclosed in JP 4713820 B, in executing a certain method, an instruction execution processing unit is configured to, when the method is already compiled, execute native codes generated by the compilation. When the method is not compiled yet, the instruction execution processing unit is configured to, for each of instructions, individually retrieve a byte-code string included in the method, and individually interpret and execute the retrieved byte-code string. At this time, the instruction execution processing unit transmits a compilation request for compiling the method, to a compilation request management unit. A compilation processing unit compiles byte-code string included in the method into native codes in response to the compilation request having been received by the compilation request management unit, and stores the native codes into a native code storage unit.

In JP 2013-61810 A, an information processing device including two CPUs (Central Processing Units) having features similar to those described above is disclosed.

### SUMMARY

An exemplary object of the present invention is to provide an information processing device that enables further improvement of throughput when instructions based on an ISA different from the ISA of native codes are processed.

An information processing device according to an example aspect of the invention includes a detection circuit a compilation execution circuit. A detection circuit is configured to detect an access to a storage by an instruction execution processor, the instruction execution processor retrieving an instruction different from a native code from the storage and executing the instruction after interpretation. A detection circuit is configured to detect an identifier of the instruction based on the detected access. A compilation execution circuit configured to compile the instruction specified by the detected identifier into one or more native codes and write the one or more native codes into the storage. In executing the instruction, when the instruction is already compiled, the instruction execution processor retrieves the one or more native codes from the storage, and executes the one or more native codes.

An information processing method according to an example aspect of the invention includes detecting an access to a storage by an instruction execution processor, the instruction execution processor retrieving an instruction different from a native code from the storage and executing the instruction after interpretation, and to detect an identifier of the instruction based on the detected access, and compiling the instruction specified by the detected identifier into one or more native codes and write the one or more native codes into the storage. In executing the instruction, when the instruction is already compiled, the instruction execution processor retrieves the one or more native codes from the storage, and executes the one or more native codes.

A non-transitory computer-readable storage medium according to an example aspect of the invention stores a program that causes an information processing device to execute detection processing and compilation processing. The detection processing includes detecting an access to a storage by an instruction execution processor, the instruction execution processor retrieving an instruction different from a native code from the storage and executing the instruction after interpretation, and to detect an identifier of the instruction based on the detected access. The compilation processing includes compiling the instruction specified by the detected identifier into one or more native codes and write the one or more native codes into the storage. In executing the instruction, when the instruction is already compiled, the instruction execution processor retrieves the one or more native codes from the storage, and executes the one or more native codes.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of an information processing device according to a first example embodiment of the present invention;

FIG. 2 is a flowchart illustrating an example of a flow of processes performed by an instruction execution processor according to the first example embodiment;

FIG. 3 is a flowchart illustrating an example of a flow of processes performed by a compilation processor according to the first example embodiment;

FIG. 4 is a flowchart illustrating another example of a flow of processes performed by the compilation processor according to the first example embodiment;

FIG. 5 is a block diagram illustrating a configuration of an information processing device according to a second example embodiment of the present invention;

FIG. 6 is a block diagram illustrating a configuration of an information processing device according to a third example embodiment of the present invention;

FIG. 7 is a block diagram illustrating another example of a configuration of the information processing device according to the third example embodiment;

FIG. 8 is a block diagram illustrating a configuration of an information processing device according to an example embodiment of the present invention;

FIG. 9 is a flowchart illustrating an example of a flow of processes performed by the information processing device according to the example embodiment of the present invention; and

FIG. 10 is a block diagram illustrating an example of a computer capable of configuring individual units of each of example embodiments of the present invention.

### EXAMPLE EMBODIMENT

Hereinafter, example embodiments of the present invention will be described in detail with reference to the drawings.

### First Example Embodiment

First, a first example embodiment of the present invention will be described.

In this first example embodiment, an information processing device 1 will be taken as an example in which the information processing device 1 includes an instruction execution processor for executing instructions and a compilation processor for performing compilation. In this regard, however, components that achieve functions that are the same as or similar to the functions of the information processing device 1 are not limited to components in a description example below. For example, the functions of both of the instruction execution processor and the compilation processor may be achieved by one multi-core processor.

<Configuration>

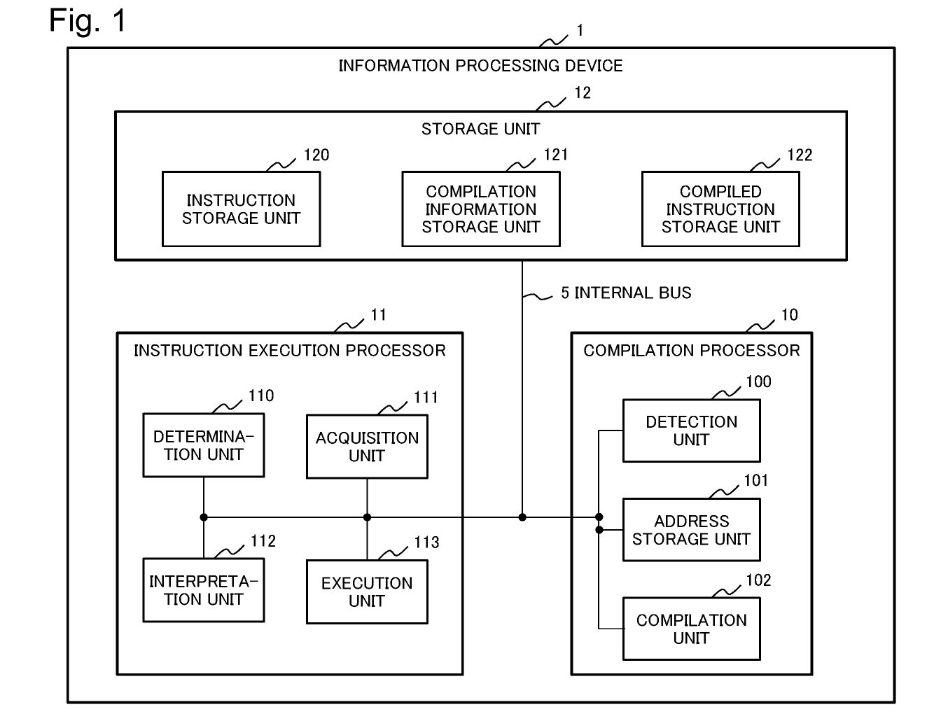

FIG. 1 is a block diagram illustrating a configuration of the information processing device 1 according to this first example embodiment.

The information processing device 1 includes a compilation processor 10, an instruction execution processor 11, and a storage unit 12. The compilation processor 10, the instruction execution processor 11, and the storage unit 12 are connected to an internal bus 5.

===Storage Unit 12===

The storage unit 12 stores therein data relating to instructions. Part of or the whole of the storage unit 12 is, for example, an aggregation of storage circuits. Part of or the whole of the storage unit 12 may be, for example, part of a main storage device (i.e., memory) of the information processing device 1. The storage unit 12 includes an instruction storage unit 120, a compilation information storage unit 121, and a compiled instruction storage unit 122. The individual units included in the storage unit 12 may be achieved by the same component, or may be achieved by mutually different components. Part of or the whole of the of storage unit 12 may be included in the instruction execution processor 11, or may be included in the compilation processor 10.

The instruction storage unit 120 stores therein a series of execution-target instructions. In the present example embodiment, the execution-target instructions stored in the instruction storage unit 120 will be also referred to as “target codes”. The target codes are, for example, intermediate codes or machine codes (i.e., instructions in a machine language). The target codes may be codes generated by converting a program written in source code. The target codes are instructions based on an ISA different from the ISA of the instruction execution processor 11.

In the present example embodiment, a series of target codes will be also referred to as a program.

The target codes each are stored in storage areas which are included in the instruction storage unit 120 and to each of which an address (for example, a memory address) is allocated. That is, each of the target codes stored in the instruction storage unit 120 is uniquely specified by designating an address. Hereinafter, an address of a storage area in which a target code is stored will be also referred to as just “an address of a target code”.

The compilation information storage unit 121 stores therein compilation information. Compilation information is information indicating whether or not a target code is already compiled. The information indicating whether or not a target code is already compiled may be represented by, for example, a compilation flag capable of taking a value indicating “compiled” or a value indicating “not compiled”. That is, in the compilation information storage unit 121, for example, identifiers (for example, addresses) for identifying target codes and the compilation flags are stored in such a manner as to be associated with each other.

Upon reception of an address, the compilation information storage unit 121 outputs a piece of compilation information associated with the received address. For example, when the value of a compilation flag associated with the received address indicates “compiled”, the compilation information storage unit 121 outputs a piece of information indicating that an instruction specified by the received address is already compiled.

The compilation information storage unit 121 may be configured to store only the addresses of compiled instructions. When only the addresses of compiled instructions are stored in the compilation information storage unit 121, a situation that the received address is stored in the compilation information storage unit 121 means that an instruction specified by the received address is already compiled. In such an embodiment, it can be said as well that the compilation information storage unit 121 stores therein compilation information. In such an embodiment, upon reception of an address, the compilation information storage unit 121 checks whether or not the received address is stored in the compilation information storage unit 121. When the received address is stored, the compilation information storage unit 121 outputs a piece of information indicating that an instruction specified by the received address is already compiled. When the received address is not stored, the compilation information storage unit 121 outputs a piece of information indicating that an instruction specified by the received address is not compiled yet.

The compiled instruction storage unit 122 stores therein compiled instructions. The compiled instructions in the present example embodiment mean native codes that are generated by compilation of instructions included in the instruction storage unit 120 by a compilation unit 102 described later. Each of the instructions stored in the compiled instruction storage unit 122 is associated with an identifier. The identifier is, for example, the address of a storage area in which the pre-compilation instruction of the each of the instructions is stored.

===Instruction Execution Processor 11===

The instruction execution processor 11 performs processing for executing target codes.

As illustrated in FIG. 1, the instruction execution processor 11 includes a determination unit 110, an acquisition unit 111, an interpretation unit 112, and an execution unit 113.

The determination unit 110 determines whether or not an instruction going to be executed (hereinafter also referred to as a “to-be-executed instruction”) is already compiled. Specifically, for example, the determination unit 110 transmits the address of a to-be-executed instruction to the compilation information storage unit 121 of the storage unit 12. The compilation information storage unit 121 transmits a piece of compilation information of an instruction specified by the transmitted address, to the determination unit 110.

From the piece of compilation information, the determination unit 110 determines whether or not the to-be-executed instruction is already compiled.

Here, the to-be-executed instruction is a target code that the execution unit 113 is going to execute next in accordance with the flow of a program. When it has been determined that the to-be-executed instruction is already compiled, the acquisition unit 111 acquires the compiled instruction generated by compilation of the to-be-executed instruction from the compiled instruction storage unit 122. In contrast, when it has been determined that the to-be-executed instruction is not compiled yet, the acquisition unit 111 retrieves the to-be-executed instruction from the instruction storage unit 120. In this processing, the acquisition unit 111 retrieves the to-be-executed instruction by, for example, designating the address of the to-be-executed instruction to the instruction storage unit 120 through the internal bus 5.

The interpretation unit 112 interprets instructions retrieved, on the grounds of not having been compiled, from the instruction storage unit 120. “Interpret (of an instruction)” means to convert the instruction into one or more native codes.

The execution unit 113 executes the native codes. That is, the execution unit 113 receives the native codes from the acquisition unit 111 or the interpretation unit 112, and performs a process in accordance with the native codes.

===Compilation Processor 10===

The compilation processor 10 compiles a target code. As illustrated in FIG. 1, the compilation processor 10 includes a detection unit 100, an address storage unit 101, and a compilation unit 102.

The detection unit 100 detects an access to the storage unit 12 by the instruction execution processor 11. Further, based on the access, the detection unit 100 detects the address of an instruction being processed (or having been processed) by the instruction execution processor 11. For example, the detection unit 100 monitors the internal bus 5. Further, for example, the detection unit 100 captures an address that the acquisition unit 111 transmits to the instruction storage unit 120 when retrieving an instruction from the instruction storage unit 120, from the internal bus 5 on which information of the address is flown. Alternatively, for example, the detection unit 100 captures, from the internal bus 5, an address that the determination unit 110 transmits to the compilation information storage unit 121.

The address storage unit 101 stores therein the detected address of the instruction.

The compilation unit 102 compiles an instruction that has not yet been compiled (hereinafter also referred to as an “uncompiled instruction”) on the basis of the stored address. In the present example embodiment, the “compile” means to convert one or more target codes into one or more native codes. Compilation by the compilation unit 102 may be a conversion that is made for each target code, just like in the process by the interpretation unit 112. The compilation unit 102 may convert a plurality of target codes at a time into a set of native codes. An embodiment where the plurality of target codes is converted at a time into a set of native codes will be described later in Modification Example 3.

The compilation unit 102 stores a native code generated by compilation into the compiled instruction storage unit 122 in a format that allows the native code to be associated with the address of an instruction from which the native code has been converted.

<Operation>

(Operation of Instruction Execution Processor 11)

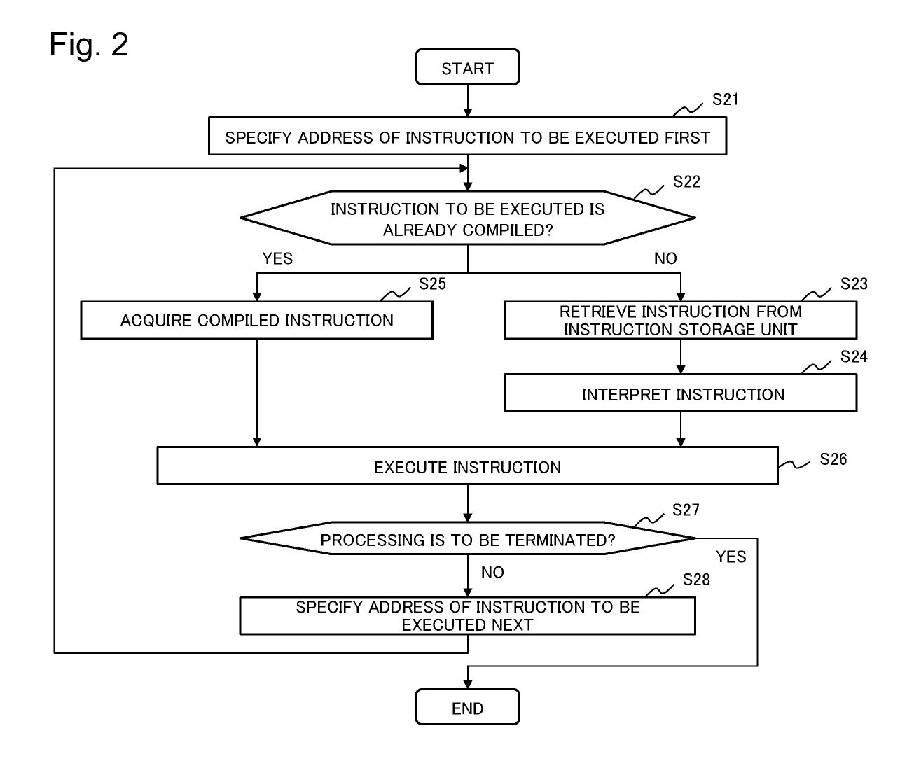

FIG. 2 is a flowchart illustrating a flow of the operation of the instruction execution processor 11.

First, the determination unit 110 specifies the address of an instruction to be executed first (step S21). At the time of the beginning of the execution of a program, the address of the instruction to be executed first is the address of a first line of the program.

Next, the determination unit 110 determines whether or not the to-be-executed instruction associated with the specified address is already compiled (step S22). For example, the determination unit 110 transmits the address of the to-be-executed instruction to the compilation information storage unit 121, and thereby acquires a piece of compilation information associated with the to-be-executed instruction. When the piece of compilation information indicates “compiled”, the determination unit 110 determines that the instruction is already compiled. When the piece of compilation information indicates “not compiled”, the determination unit 110 determines that the instruction is not compiled yet.

When the to-be-executed instruction is not compiled yet (NO in step S22), the acquisition unit 111 retrieves the to-be-executed instruction from the instruction storage unit 120 on the basis of the address of the to-be-executed instruction (step S23). Then, the interpretation unit 112 interprets the retrieved instruction (step S24). The interpretation unit 112 transmits a native code generated by the interpretation to the execution unit 113. Subsequently to this process, a process of step S26 will be performed next.

When the to-be-executed instruction is already compiled (YES in step S22), the acquisition unit 111 acquires the compiled instruction generated by compilation of the to-be-executed instruction from the compiled instruction storage unit 122, on the basis of the address of the to-be-executed instruction (step S25). The acquisition unit 111 transmits the acquired instruction to the execution unit 113. Subsequently to this process, the process of step S26 will be performed next.

In step S26, the execution unit 113 executes the instruction having been received from the acquisition unit 111 or the interpretation unit 112.

After the execution of the instruction, when processing for executing the program is to be terminated (YES in step S27), the processing is terminated. When the processing for executing the program is continued (NO in step S27), the determination unit 110 specifies the address of an instruction to be executed next (step S28). For example, when an instruction having been executed last is a jump instruction, the address of a to-be-executed instruction is a destination address of a jumping operation based on the jump instruction. When the instruction having been executed last is not the jump instruction, the address of the to-be-executed instruction is the address following the address of an instruction having been immediately previously executed, that is, the instruction having been executed last.

For the specified address, the determination unit 110 makes the determination in step S22 again. Thereafter, similarly, for the address of the to-be-executed instruction, the instruction execution processor 11 performs processes among the processes of steps S23 to S26 on the basis of a result of the determination in step S22.

(Operation of Compilation Processor 10)

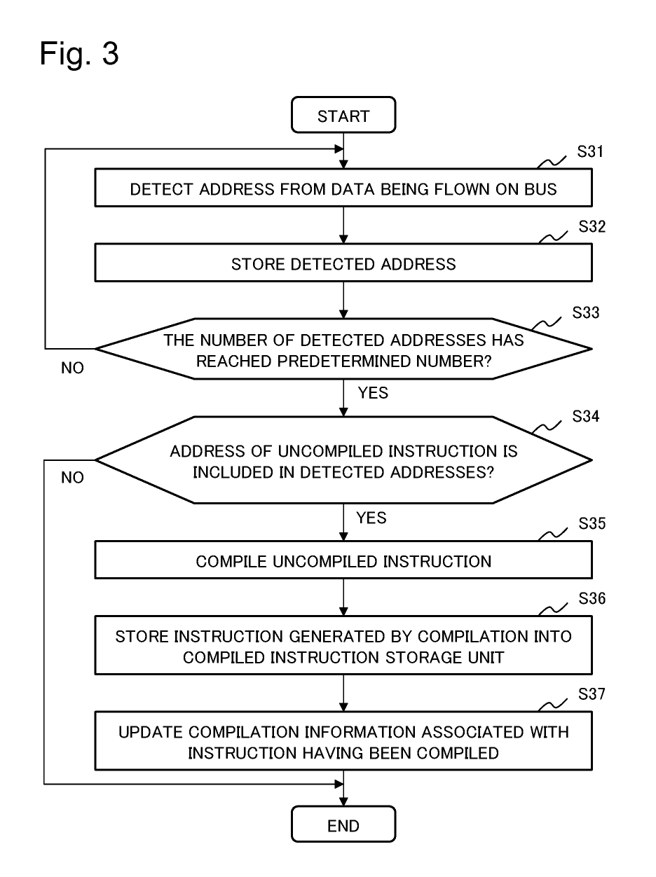

FIG. 3 is a flowchart illustrating a flow of the processes performed by the compilation processor 10.

The compilation processor 10 repeatedly performs the processes of the flow illustrated in the flowchart of FIG. 3 during a period, for example, from the beginning until the end of the execution by the instruction execution processor 11 on target codes included in the instruction storage unit 120.

First, the detection unit 100 acquires the address of an instruction that the instruction execution processor 11 is going to process, from data being flown on the internal bus 5 (step S31). For example, the detection unit 100 monitors the content of a certain process being performed by the instruction execution processor 11. The content of the certain process is being flown on the internal bus 5. Subsequently, from the content of the certain process, the detection unit 100 detects the address of an instruction included in the instruction storage unit 120.

Specifically, the content of the certain process, which is monitored by the detection unit 100, is, for example, data transmitted/received in the process of step S22 (i.e., the acquisition of a piece of compilation information) or in the process of step S23 (i.e., the retrieval of a to-be-executed instruction from the instruction storage unit 120) in the flowchart illustrated in FIG. 2. The detection unit 100 captures, so to say, an address included in the data transmitted/received by the instruction execution processor 11.

Further, the detection unit 100 stores the detected address into the address storage unit 101. The address storage unit 101 stores therein the address having been detected by the detection unit 100 (step S32). In this regard, however, when the same address as an already-stored address has been detected, the address storage unit 101 may avoid storing therein the detected address newly.

In step S33, the compilation unit 102 determines whether or not the number of detected addresses has reached a predetermined number. For this determination, for example, the compilation unit 102 may perform processing for incrementing the value of counting by one every time an address is detected. Further, every time an address is detected, the compilation unit 102 may determine whether or not the value of the counting has reached a predetermined value. The trigger of incrementing the value of the counting may be the time point when the detection unit 100 has detected an address, or may be the time point when the address storage unit 101 stores the address therein. When the address storage unit 101 stores the address therein, the address storage unit 101 may transmit the stored address to the compilation unit 102. Alternatively, the compilation unit 102 may acquire the number of addresses having been stored in the address storage unit 101 by monitoring the address to be stored in the address storage unit 101 using an interruption or the like. The compilation unit 102 may count only an address different from one or more already-detected addresses. That is, the compilation unit 102 may be configured not to increment the value of the counting when a detected address corresponds to any one of addresses having been detected during a period while the value of the counting has been incremented to a current value from “0”.

Note that the determination process of step S33 may be performed by a component other than the compilation unit 102 (e.g., the address storage unit 101 or any other unillustrated component).

When the number of the detected addresses has not yet reached the predetermined number (NO in step S33), the compilation unit 102 continues waiting for a further detection of an address. When the number of the detected addresses has reached the predetermined number (YES in step S33), a process of step S34 is performed. When the process of step S34 has been performed, the value of the counting may be reset.

The “predetermined number” in step S33 may be set at the time of designing the compilation processor 10, or may be a numerical value capable of being set and changed in accordance with a direction from the outside, or the like. The predetermined number can be set to any number larger than or equal to “1”. The determination as to “whether or not the predetermined number has been reached” in step S33 may be a determination as to “whether or not the predetermined value has been exceeded (by the value of the counting)”. In such a case, the predetermined value is a number larger than or equal to “0”.

In step S34, the compilation unit 102 determines whether or not the addresses of one or more uncompiled instructions are included in the detected addresses. The “detected addresses” in the present description indicate one or more addresses having been detected during a period from the timing point when the value of the counting was “0” until the timing point when the value of the counting has reached the predetermined value. For example, the compilation unit 102 checks whether or not each of one or more instructions specified by the detected addresses is already compiled.

As a method for this checking, for example, the compilation unit 102 may transmit the detected addresses to the compilation information storage unit 121, and thereby may acquire one or more pieces of compilation information each associated with the detected addresses. Alternatively, the compilation processor 10 may retain the compilation information in its internal register or the like. By such configuration, the compilation unit 102 is capable of acquiring the one or more pieces of compilation information each associated with the detected addresses by referring to the retained compilation information.

When the address of an uncompiled instruction is not included at all in the detected addresses (NO in step S34), the processing is terminated. In this processing, after the value of the counting has been set to “0” and the addresses stored in the address storage unit 101 have been cleared, the process of step S31 may be started again. The addresses stored in the address storage unit 101 may not be necessarily cleared. In such a case, the address storage unit 101 stores the addresses in a form that enables addresses stored before the setting of the value of the counting into “0” and addresses stored after the setting of the value of the counting into “0” to be distinguished from each other.

When the addresses of uncompiled instructions are included in the detected addresses (YES in step S34), the compilation unit 102 compiles the one or more uncompiled instructions (step S35). For example, the compilation unit 102 retrieves one or more uncompiled instructions from the instruction storage unit 120 on the basis of the addresses of the one or more uncompiled instructions. Further, the compilation unit 102 compiles the one or more uncompiled instructions having been retrieved, into one or more native codes.

The compilation unit 102 may compile only the one or more uncompiled instructions, or may compile the one or more uncompiled instructions together with one or more compiled instructions at a time.

Upon completion of the compilation, the compilation unit 102 writes the one or more native codes, generated by the compilation, into the compiled instruction storage unit 122 (step S36). At this time, the compilation unit 102 writes the one or more native codes in a format that allows each of the one or more native codes to be associated with the address of an instruction from which the one or more native codes have been converted. With this configuration, in the process of step S25, the acquisition unit 111 is capable of retrieving one or more native codes using the address of an instruction from which the one or more native codes have been converted.

Moreover, the compilation unit 102 updates compilation information stored in the compilation information storage unit 121 (step S37). Specifically, for example, the compilation unit 102 rewrites the values of one or more pieces of compilation information each associated with the one or more instructions having been compiled, into the value indicating “compiled”. When the compilation information storage unit 121 is configured to store therein only the addresses of one or more compiled instructions, the compilation unit 102 may merely write the addresses of the one or more instructions having been compiled, into the compilation information storage unit 121.

Another Example of Operation of Compilation Processor 10

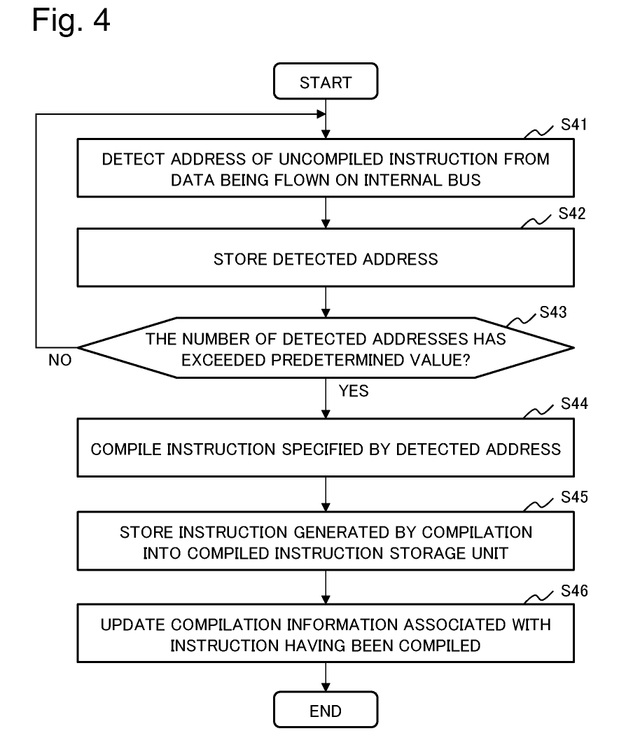

FIG. 4 is a flowchart illustrating another example of the flow of the operation of the compilation processor 10. The compilation processor 10 repeatedly performs the processes of the flow illustrated in the flowchart of FIG. 4 during a period, for example, from the beginning until the end of the execution by the instruction execution processor 11 on target codes included in the instruction storage unit 120.

In the flowchart illustrated in FIG. 4, in step S41, the detection unit 100 detects the address of an uncompiled instruction from data being flown on the bus.

For example, the detection unit 100 captures the process performed by the instruction execution processor 11 in step S23 of the flowchart illustrated in FIG. 2 (i.e., the process being the retrieval of an instruction via the internal bus). Further, the detection unit 100 detects an address designated by the instruction execution processor 11. The address designated by the instruction execution processor 11 is the address of an uncompiled instruction.

Alternatively, for example, the detection unit 100 may detect the process of retrieving a piece of compilation information via the internal bus 5 in the process performed by the instruction execution processor 11 in step S22 of the flowchart illustrated in FIG. 2. Further, the detection unit 100 may detect an address that the instruction execution processor 11 is transmitting in order to retrieve the piece of compilation information. In this regard, however, this address is not necessarily the address of an uncompiled instruction. The detection unit 100 may further detect a piece of compilation information provided by the compilation information storage unit 121. When the piece of compilation information indicates “compiled”, the detection unit 100 may specify that the detected address is the address of a compiled instruction. Alternatively, the detection unit 100 may determine whether or not the detected address is an address having been already detected as the address of a compiled instruction. The detection unit 100 is capable of specifying whether or not the detected address is an address having been already detected as the address of a compiled instruction, provided that, for example, all of addresses having been detected as the addresses of compiled instructions are stored in the address storage unit 101.

In this way, the detection unit 100 detects the address of an uncompiled instruction. The detection unit 100 stores the detected address of an uncompiled instruction into the address storage unit 101.

The address storage unit 101 stores therein the detected address of an uncompiled instruction (step S42). In this regard, however, when the same address as an already-stored address has been detected, the address storage unit 101 may avoid storing therein the address newly.

The compilation unit 102 determines whether or not the number of detected addresses has exceeded a predetermined value (step S43). This determination process may be performed by a component other than the address storage unit 101. When the number of the detected addresses has not yet exceeded the predetermined value (NO in step S43), the compilation unit 102 continues waiting for a new detection of the address of an uncompiled instruction. When the number of detected addresses has exceeded the predetermined value (YES in step S43), a process of step S44 is performed.

In step S44, based on the addresses having been detected and stored in the address storage unit 101, the compilation unit 102 compiles one or more instructions each specified by the addresses. Specifically, the compilation unit 102 retrieves the relevant one or more instructions from the instruction storage unit 120 using the addresses stored in the address storage unit 101. Further, the compilation unit 102 compiles the retrieved one or more instructions, and generates one or more native codes as the result of the compilation.

The compilation unit 102 writes the one or more native codes generated by the compilation into the compiled instruction storage unit 122 (step S45). Further, the compilation unit 102 updates one or more pieces of compilation information each associated with the one or more instructions having been compiled (step S46). The process of step S45 and the process of step S46 may be respectively similar to the process of step S36 and the process of step S37.

Upon completion of the processes in steps S45 and S46, the series of processes are terminated. When the program is still under execution, the process of step S41 may be started again.

<Advantageous Effect>

The information processing device 1 according to this first example embodiment enables the improvement of the efficiency in execution of instructions.

The instruction execution processor 11 of the information processing device 1 is configured to, when an execution-target instruction is already compiled, acquire and execute the execution-target instruction, that is, one or more native codes, and to, when the execution-target instruction has not yet compiled, execute the execution-target instruction after interpretation. At this time, it is unnecessary for the instruction execution processor 11 to make a compilation request for compiling the uncompiled instruction to the compilation processor 10. The reason of this is that the compilation processor 10 monitors the content of a certain process performed by the instruction execution processor 11, and thereby detects an address included in the content of the certain process.

In this way, it is unnecessary for the instruction execution processor 11 to perform a process of making the compilation request, and thus, throughput in relation to the execution of instructions by the instruction execution processor 11 is expected to be higher than in each of the technologies of JP 4713820 B and JP 2013-61810 A.

Further, according to the process of step S33, the compilation unit 102 is configured to, each time the number of addresses detected since the last execution of compilation reaches a predetermined number, compile one or more instructions each being specified by the detected addresses and being not compiled yet. In an embodiment where the “predetermined number” is larger than or equal to “2”, the frequency of a process relating to compilation and performed by the compilation unit 102 is reduced to a lower level than in an embodiment where the predetermined number is “1” (that is, in an embodiment where every time one address is detected, a compilation process is performed). For example, the number of the execution times of the process of step S34 is reduced. Moreover, the compilation unit 102 is capable of performing the process of each of steps S35 to S37 on a plurality of instructions at a time, and thus, the efficiency in this configuration is higher than in a configuration in which the process of each of steps S35 to S37 is performed for each of the instructions.

### Modification Example 1

In the above example embodiment, it is described that an address is associated with an instruction, a native code, and a piece of compilation information. In this regard, however, in the identification and specification of information relating to an instruction, the address is not necessarily used, but any identifier capable of uniquely identifying the information is applicable. For example, a number different from the address may be associated with each native code and each piece of compilation information. In such a case, the number may be used instead of the address in the processes performed by the determination unit 110 in steps S22 and S25, and the individual processes performed by the compilation processor 10.

### Modification Example 2

The detection unit 100 may detect an instruction. For example, upon detection of an address, the detection unit 100 may access the instruction storage unit 120 to acquire an instruction specified by the detected address. Alternatively, for example, the detection unit 100 may detect an instruction having been retrieved from a bus through which the acquisition unit 111 retrieves a target code from the instruction storage unit 120.

Further, the detection unit 100 may transmit the detected instruction to the compilation unit 102.

The compilation unit 102 may retain the detected instruction therein. Retainment of the instruction by the compilation unit 102 brings about an advantageous effect that it is unnecessary for the compilation unit 102 to retrieve any instruction from the instruction storage unit 120 in the process of step S35 and, as a result, processing in the execution of compilation is speeded up.

### Modification Example 3

The compilation unit 102 may convert a plurality of target codes at a time into a set of native codes. That is, the compilation unit 102 may convert a plurality of target codes into a set of native codes that is processed more effectively than when the target codes are individually interpreted.

In such a case, the compilation unit 102 may stores the generated set of native codes into the compiled instruction storage unit 122 in a format that allows a set of addresses specifying target codes before compilation to be associated with the generated set of native codes. For example, when having compiled, at a time, instructions whose addresses are from “00000100” to “00001000”, the compilation unit 102 causes a generated set of native codes to be stored in a format that allows a piece of information indicating “from 00000100 to 00001000” to be associated with the generated set of native codes. Further, the compilation unit 102 stores, into the compilation information storage unit 121, a piece of information indicating that a set of instructions whose addresses are from “00000100” to “00001000” are compiled.

In this case, upon reception of an inquiry from the determination unit 110 for a piece of compilation information about an address “00000100” which is the address of to-be-executed instructions, the compilation information storage unit 121 returns the piece of information indicating that a set of instructions whose addresses are from “00000100” to “00001000” are compiled, to the determination unit 110. In this case, the acquisition unit 111 acquires the set of native codes associated with the piece of information indicating “from 00000100 to 00001000”, from the compiled instruction storage unit 122. After the execution of processes indicated by the set of native codes, the address of an instruction to be executed next is an address (“00001001”) following the address (“00001000”).

As another configuration, when the compilation unit 102 is configured to compile a plurality of target codes at a time, the compilation unit 102 may generate and add a jump instruction that causes processing to jump to the address of an instruction to be executed immediately after the execution of a generated set of native codes. In this case, in the compiled instruction storage unit 120, only the address of a first target code among the set of target codes before the compilation may be associated with the generated set of native codes. For example, when instructions whose addresses are from “00000100” to “00001000” have been compiled at a time, the compilation unit 102 may add, to the ending of the set of native codes after the compilation, an instruction that causes processing to jump to the address “00001001”. With this configuration, after an instruction processing unit 31 has executed the set of native codes having been retrieved on the basis of the address “00000100”, the address of an instruction to be executed next is specified to the address “00001001”.

In the above process, so that a program is correctly executed, when performing the compilation, the compilation unit 102 compiles an aggregation of target codes in which no branch exists (that is, the content of each of to-be-executed instructions and order in which the instructions are executed are not limited by the content of processing).

According to such a modification example, a set of native codes including a further effective execution procedure are generated by the compilation unit 102 and, as a result, the efficiency in the execution of instructions is further improved.

### Second Example Embodiment

A second example embodiment of the present invention will be described below.

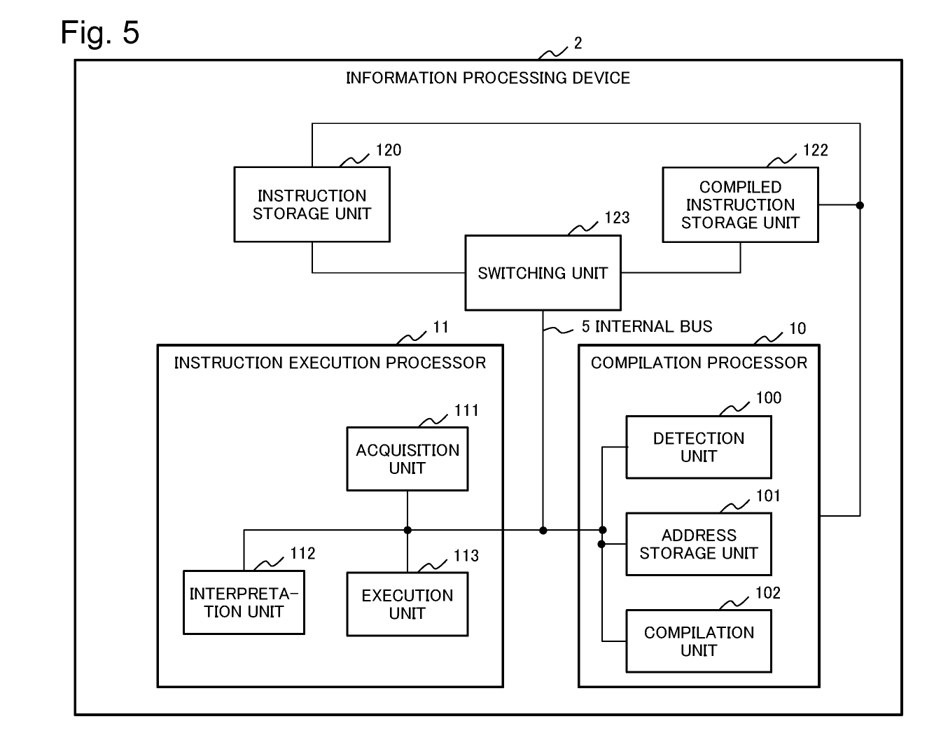

FIG. 5 is a block diagram illustrating a configuration of an information processing device 2 according to this second example embodiment. The information processing device 2 is configured to include a switching unit 123. The instruction execution processor 11 may be configured not to include the determination unit 110.

The acquisition unit 111 transmit the address of a to-be-executed instruction to the switching unit 123.

The switching unit 123 switches a path through which the acquisition unit 111 of the instruction execution processor 11 retrieves the to-be-executed instruction on the basis of the address having been transmitted from the acquisition unit 111. Specifically, when a received address is the address of a compiled instruction, the switching unit 123 sets the path to a path through which the acquisition unit 111 retrieves an instruction from the compiled instruction storage unit 122. When the received address is the address of an uncompiled instruction, the switching unit 123 sets the path to a path through which the acquisition unit 111 retrieves an instruction from the instruction storage unit 120. The switching unit 123 sets, so to say, one of mutually different paths depending on whether or not an instruction specified by a received address is already compiled.

In order to achieve the above function, the switching unit 123 includes, for each address, a piece of compilation information indicating whether or not an instruction specified by the address is already compiled. Thus, it can be said that the switching unit 123 is a modification example of the compilation information storage unit 121 in the first example embodiment.

With the function of the switching unit 123, the acquisition unit 111 is capable of acquiring an instruction from the compiled instruction storage unit 122 when a to-be-executed instruction is already compiled, and of acquiring an instruction from the instruction storage unit 120 when the to-be-executed instruction is not compiled yet.

The functions of constituent elements that are not particularly noted in the description of the present example embodiment are the same as or similar to the functions of constituent elements included in the first example embodiment and denoted by the same reference signs as those of the relevant constituent elements of the present example embodiment.

The detection unit 100 detects an address output by the acquisition unit 111 from, for example, a bus through which the acquisition unit 111 and the switching unit 123 are connected to each other. The detection unit 100 detects an address from, for example, process content that the acquisition unit 111 outputs when retrieving an instruction from the instruction storage unit 120 or the compiled instruction storage unit 122.

With such a configuration as described above, the information processing device 2 is capable of performing instruction execution with high-level throughput, just like the information processing device 1. Further, in comparison with the first example embodiment, the process by the instruction execution processor 11 for receiving a piece of compilation information is unnecessary, and thus, an advantageous effect that the efficiency in the processing performed by the instruction execution processor 11 is further improved is brought about.

Note that the modification examples and the changeable items having been described in the first example embodiment are also applicable in this second example embodiment.

### Third Example Embodiment

A third example embodiment of the present invention will be described below.

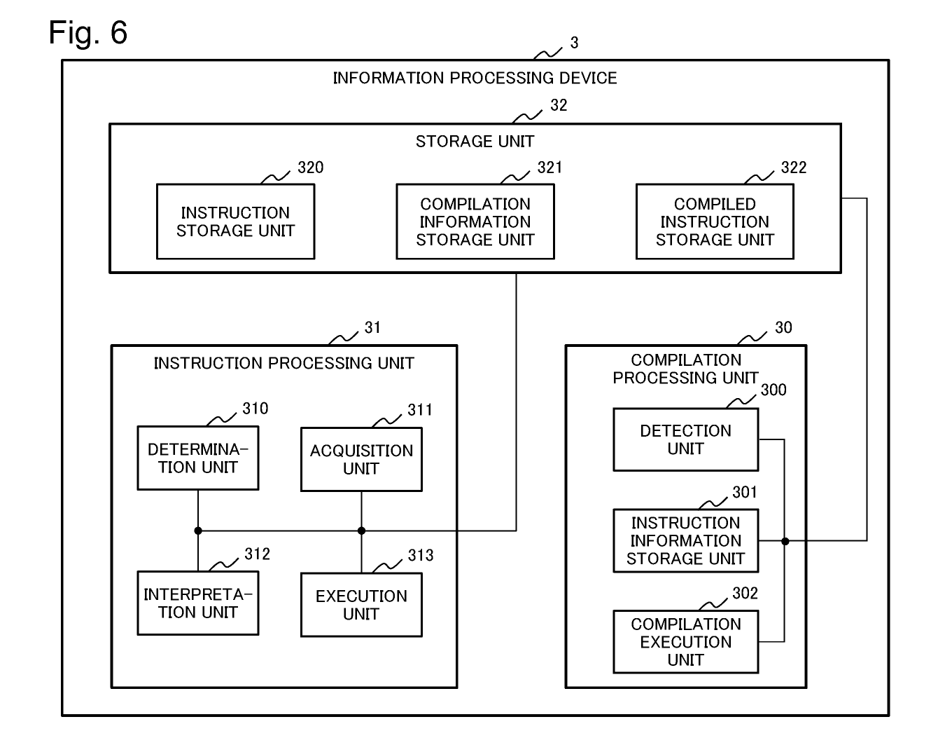

FIG. 6 is a block diagram illustrating a configuration of an information processing device 3 according to the third example embodiment of the present invention. The information processing device 3 includes a compilation processing unit 30, an instruction processing unit 31, and a storage unit 32. Individual units of the information processing device 3 are not needed to be connected to one another via the same bus differently from the individual units of the information processing device 1.

The storage unit 32 includes an instruction storage unit 320, a compilation information storage unit 321, and a compiled instruction storage unit 322.

The instruction storage unit 320 stores therein target codes that are the targets of execution. The instruction storage unit 320 in this third example embodiment may be similar to the instruction storage unit 120 in the first example embodiment.

The compilation information storage unit 321 stores therein compilation information.

The compiled instruction storage unit 322 stores therein native codes that are generated as a result of compilation of the target codes.

The instruction processing unit 31 includes a determination unit 310, an acquisition unit 311, an interpretation unit 312, and an execution unit 313. The functions of the individual units of the instruction processing unit 31 may be achieved using a processor that executes software. Part of or the whole of the instruction processing unit 31 may be achieved using one or more circuits.

The determination unit 310 determines whether or not a to-be-executed instruction is already compiled. In order to make such a determination, the determination unit 310 refers to the compilation information stored in the compilation information storage unit 321.

Based on the result of the determination by the determination unit 310, the acquisition unit 311 acquires an instruction from the instruction storage unit 320 or the compiled instruction storage unit 322. Specifically, when the to-be-executed instruction is already compiled, the acquisition unit 311 acquires the native code of the to-be-executed instruction from the compiled instruction storage unit 322. When the to-be-executed instruction is not compiled yet, the acquisition unit 311 acquires the to-be-executed instruction from the instruction storage unit 320.

The interpretation unit 312 interprets the to-be-executed instruction having been acquired from the instruction storage unit 320 by the acquisition unit 311. The function of the interpretation unit 312 may be similar to the function of the interpretation unit 112 of the first example embodiment.

The execution unit 313 receives a native code from the acquisition unit 311 or the interpretation unit 312, and performs a process indicated by the native code. The execution unit 313 may be a processor, or may be a system directing a processor to execute the native code.

The compilation processing unit 30 includes a detection unit 300, an instruction information storage unit 301, and a compilation execution unit 302.

The detection unit 300 detects a piece of information of an instruction having been handled by the instruction processing unit 31. This piece of information is also referred to as a piece of “instruction information” hereinafter. The piece of information of an instruction is, for example, an address at which the instruction is stored. As a method by the detection unit 300 for detecting the piece of instruction information, there exists, for example, a method of acquiring a piece of information of an instruction for which a piece of compilation information has been referred to, from the compilation information storage unit 321. For example, upon reception of a reference to a piece of compilation information from the determination unit 310 of the instruction processing unit 31, the compilation information storage unit 321 stores therein a piece of instruction information of an instruction targeted for the reference, as a piece of data. With this configuration, through a reference to the piece of data having been stored by the compilation information storage unit 321, the detection unit 300 is capable of specifying the instruction for which the piece of compilation information has been referred to, that is, the instruction having been handled by the instruction processing unit 31. Alternatively, for example, upon reception of a reference to a piece of compilation information from the determination unit 310, the compilation information storage unit 321 may transmit a piece of instruction information of an instruction targeted for the reference to the detection unit 300.

As another method, the detection unit 300 may acquire a piece of information of an instruction having been acquired from the instruction storage unit 320 by the acquisition unit 311, from the instruction storage unit 320. The piece of information of the acquired instruction may be stored by the instruction storage unit 320, and the detection unit 300 may retrieve the stored piece of information. Alternatively, every time an instruction is retrieved, the instruction storage unit 320 may transmit a piece of information of the retrieved instruction to the detection unit 300.

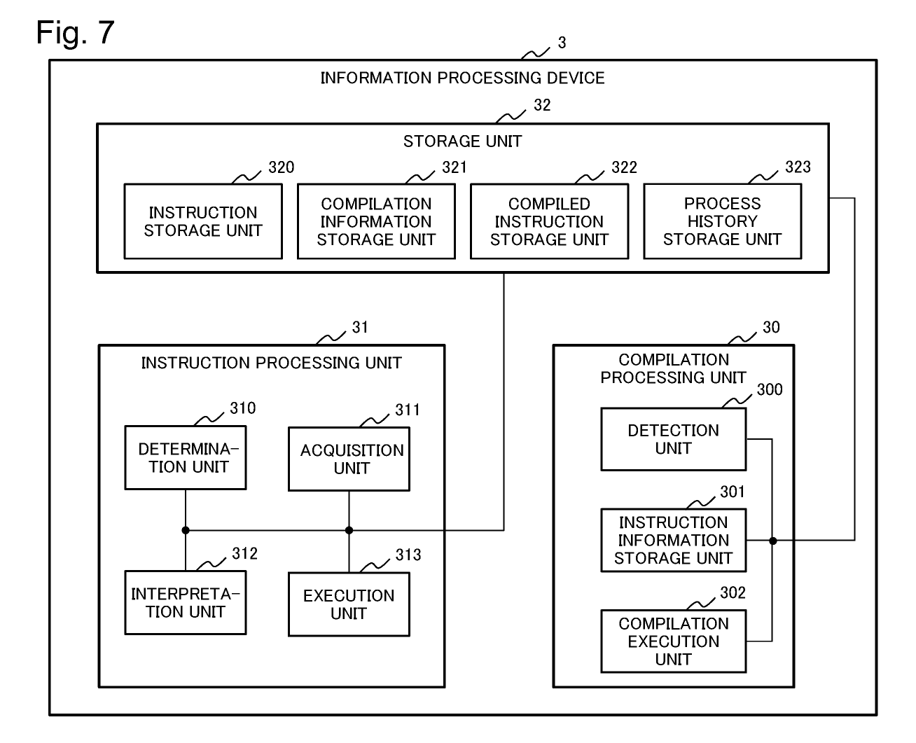

As illustrated in FIG. 7, the information processing device 3 may include a process history storage unit 323 as a component included in the storage unit 32. That is, pieces of information of instructions having been handled by the instruction processing unit 31 may be stored by the process history storage unit 323. For example, the process history storage unit 323 may acquire from the compilation information storage unit 321 a piece of information of an instruction for which a piece of compilation information have been referred to, or may acquire from the instruction storage unit 320 a piece of information of an instruction having been retrieved by the instruction processing unit 31. Alternatively, the process history storage unit 323 may directly receive the address of a to-be-executed instruction from the instruction processing unit 31. Further, the detection unit 300 may detect a piece of instruction information of an instruction having been handled by the instruction processing unit 31 by referring to the process history storage unit 323.

The instruction information storage unit 301 stores therein the piece of instruction information having been detected by the detection unit 300.

The compilation execution unit 302 compiles one or more instructions each indicated by one or more pieces of instruction information having been stored in the instruction information storage unit 301. For example, each time the number of pieces of instruction information having been newly stored in the instruction information storage unit 301 since the last execution of compilation reaches a predetermined number, the compilation execution unit 302 may compile one or more instructions each indicated by the one or more pieces of instruction information having been stored. The compilation execution unit 302 may specify one or more not-yet-compiled instructions, and then may compile only the one or more specified instruction. The function of the compilation execution unit 302 may be similar to the function of the compilation unit 102 of the first example embodiment.

The compilation execution unit 302 stores one or more native codes generated by the compilation into the compiled instruction storage unit 322.

With the above configuration, the information processing device 3 is capable of performing the execution of instructions further effectively, just like the information processing device 1.

### Fourth Example Embodiment

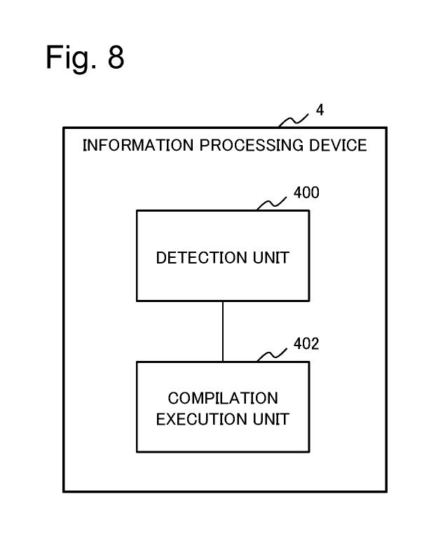

An information processing device 4 according to an example embodiment of the present invention will be described below. FIG. 8 is a block diagram illustrating a configuration of the information processing device 4. The information processing device 4 includes a detection unit 400 and a compilation execution unit 402.

The detection unit 400 detects an access to a storage unit by an instruction execution unit, and detects an identifier of an instruction on the basis of the detected access. Here, the instruction execution unit is a unit for retrieving an instruction different from a native code from the storage unit, and then interpreting and executing the retrieved instruction. The storage unit is a hardware component or a set of a plurality of hardware components which stores information. The instruction execution unit and the storage unit may be included in the information processing device 4, or may exist as components disposed outside the information processing device 4.

The compilation execution unit 402 compiles an instruction specified by the detected identifier, and writes a native code generated by compilation into the storage unit.

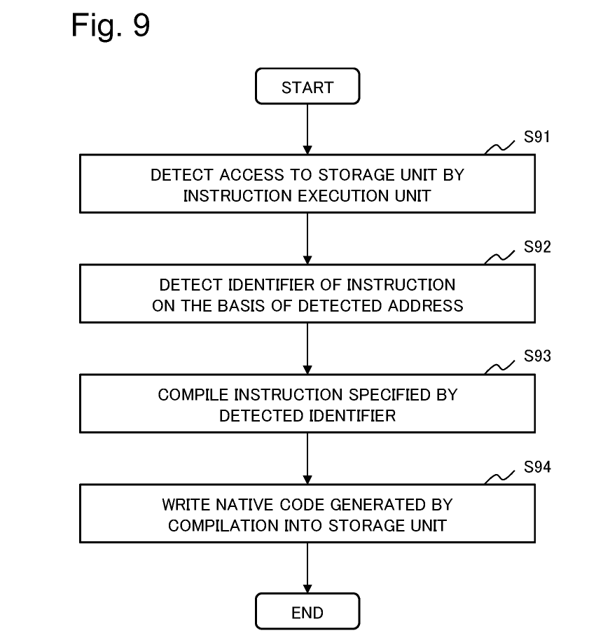

FIG. 9 is a flowchart illustrating a flow of processes performed by the information processing device 4. First, the detection unit 400 detects an access to the storage unit by the instruction executing unit (step S91). The access detected by the detection unit 400 is, for example, an access for retrieving an instruction different from a native code from the storage unit. Alternatively, similarly to the example embodiments having been already described, the detection unit 400 may detect an access for determining whether or not a to-be-executed instruction is already compiled. Further, on the basis of the detected access, the detection unit 400 detects an identifier that is associated with an instruction and that is being used (or that has been used) in the access (step S92). Next, the compilation execution unit 402 compiles one or more instruction each specified by one or more detected identifiers (step S93). Further, the compilation execution unit 402 writes one or more native codes generated by the compilation into the storage unit (step S94).

According to the information processing device 4, the instruction execution unit is capable of acquiring a native code generated by compilation from the storage unit. Throughput in relation to the execution of instructions by the instruction execution unit in this configuration is further improved, as compared with a configuration in which all instructions are executed while being interpreted one by one, and a configuration in which requests for performing compilation are made.

<<Regarding Hardware Configuration>>

Heretofore, in the individual above-described example embodiments of the present invention, each of the constituent elements of each of the devices is denoted by a block for each function.

Part of or the whole of each of the constituent elements of each of the devices is achieved using, for example, a general-purpose circuit or a dedicated circuit. Each of the constituent elements may be achieved by a single chip, or may be achieved by a plurality of chips connected to one another via a bus.

Within a scope not exceeding the technical thought of the present invention, part of or the whole of constituent elements of each of the example embodiments may be achieved by, for example, allowing a computer system to retrieve a program from a computer-readable storage medium in which the program is stored, and execute the retrieved program. A non-limiting example of the “computer system” is a system including a computer 900 including the following components:

one or more CPUs 901;

a ROM (Read Only Memory) 902; a RAM (Random Access Memory) 903;

a program 904A and stored information 904B that are loaded into the RAM 903;

a storage device 905 for storing therein the program 904A and the stored information 904B;

a drive device 907 for performing reading/writing to/from a storage medium 906;

a communication interface 908 connected to a communication network 909;

an input/output interface 910 for performing input/output of data; and

a bus 911 through which relevant individual constituent elements are connected to one another.

For example, each of the constituent elements of each of the devices in the respective example embodiments is achieved by allowing the CPU 901 to load the program 904A for achieving the function of the each of the constituent elements into the RAM 903, and to execute the program 904A. The program 904A for achieving the function of the each of the constituent elements of each of the devices is stored in advance in, for example, the storage device 905 or the ROM 902. Further, the CPU 901 retrieves the program 904A when needed. The storage device 905 is, for example, a hard disk. The program 904A may be supplied to the CPU 901 via the communication network 909, or may be stored in the storage medium 906 in advance and may be supplied to the CPU 901 by being retrieved by the drive device 907. Here, the storage medium 906 is a portable medium, such as an optical disk, a magnetic disk, a magneto-optical disk, and a nonvolatile-semiconductor memory.

The aforementioned ROM 902, storage device 905, and storage medium 906 are just examples of the “computer-readable storage medium”. In addition to these storage media, examples of the “computer-readable storage medium” further include elements: one of the elements being an element that dynamically retains a program during a short period, such as a communication line, in an embodiment where the program is transmitted via a network such as the Internet, or a communication link such as a telephone link; the other one of the elements being an element that temporarily retains the program, such as a volatile memory inside a computer system corresponding to a server or a client in the embodiment where the program is transmitted via a network or a communication link. The program may be a program that achieves part of the aforementioned functions, and further may be a program that achieves the aforementioned functions in combination with one or more programs that are already stored in the computer system.

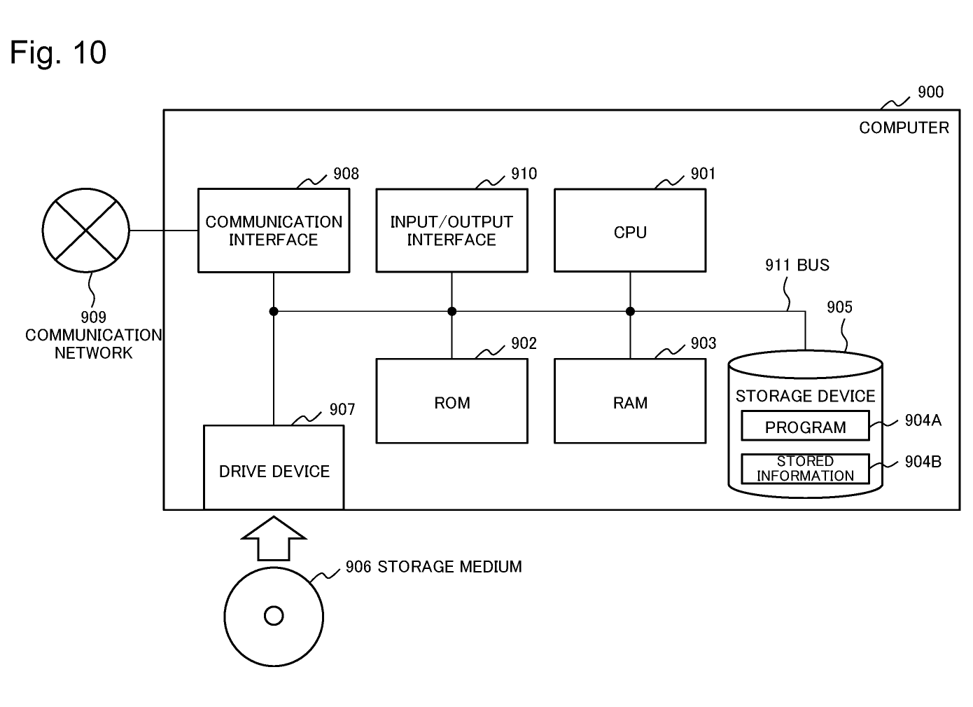

The computer 900 may not need to include part of the components illustrated in FIG. 10 (for example, the drive device 907 and the communication interface 908), as far as the required functions are achieved.

There are various modification examples in the method of achieving each of the devices. For example, each of the devices may be achieved, for each of its constituent elements, using an available combination of an independent computer 900 and a program. Further, a plurality of constituent elements included in each of the devices may be achieved using an available combination of one computer 900 and a program.

In an embodiment where part of or the whole of each of the constituent elements of each of the devices is achieved using a plurality of one or more computers, one or more circuits, and/or the like, the plurality of one or more computers, one or more circuits, and/or the like may be disposed in a concentrated manner, or may be disposed in a distributed manner. For example, the plurality of one or more computers, one or more circuits, and/or the like may be achieved in a form, such as a client and server system or a cloud computing system, that allows the plurality of one or more computers, one or more circuits, and/or the like to be connected to one another via one or more communication networks.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

<Supplementary Notes>

(Supplementary Note 1)

An information processing device comprising:

a detection circuit configured to detect an access to a storage by an instruction execution processor, the instruction execution processor retrieving an instruction different from a native code from the storage and executing the instruction after interpretation, and to detect an identifier of the instruction based on the detected access; and

a compilation execution circuit configured to compile the instruction specified by the detected identifier into one or more native codes and write the one or more native codes into the storage,

wherein, in executing the instruction, when the instruction is already compiled, the instruction execution processor retrieves the one or more native codes from the storage, and executes the one or more native codes.

(Supplementary Note 2)

The information processing device according to Supplementary Note 1, wherein

the storage stores information indicating whether or not the instruction is already compiled, and

when executing the instruction, the instruction execution processor determines, by accessing the storage, whether or not the instruction is already compiled.

(Supplementary Note 3)

The information processing device according to Supplementary Note 1 or 2, wherein, each time a count of identifiers detected by the detection circuit since last compilation by the compilation execution circuit reaches a predetermined number, the compilation execution circuit compiles instructions that is not compiled yet among instructions specified by the detected identifiers.

(Supplementary Note 4)

The information processing device according to Supplementary Note 1 or 2, wherein, each time a count of detected identifiers of instructions which are not compiled yet reaches a predetermined number, the compilation execution circuit compiles, at a time, the instructions which are not compiled yet.

(Supplementary Note 5)

The information processing device according to any one of Supplementary Notes 1 to 4, wherein, based on an access through which the instruction execution processor retrieves the instruction from the storage, the detection circuit retrieves an identifier of the instruction being retrieved.

(Supplementary Note 6)

The information processing device according to any one of Supplementary Notes 1 to 4, wherein the detection circuit determines whether or not the identifier specified based on the access is an identifier of the instruction that is not compiled yet, and detects an identifier having been determined to be the identifier of the instruction that is not compiled yet, as an identifier of the instruction to be compiled by the compilation execution circuit.

(Supplementary Note 7)

The information processing device according to any one of Supplementary Notes 1 to 6, wherein the detection circuit retrieves, when detecting the identifier, the instruction specified by the identifier, and the compilation execution circuit compiles the instruction having been retrieved by the detection circuit.

(Supplementary Note 8)

The information processing device according to any one of

Supplementary Notes 1 to 7, further comprising:

the instruction execution processor; and

the storage.

(Supplementary Note 9)

An information processing method comprising:

detecting an access to a storage by an instruction execution processor, the instruction execution processor retrieving an instruction different from a native code from the storage and executing the instruction after interpretation, and to detect an identifier of the instruction based on the detected access; and compiling the instruction specified by the detected identifier into one or more native codes and write the one or more native codes into the storage, wherein, in executing the instruction, when the instruction is already compiled, the instruction execution processor retrieves the one or more native codes from the storage, and executes the one or more native codes.

(Supplementary Note 10)

The information processing method according to Supplementary Note 9, wherein

the storage stores information indicating whether or not the instruction is already compiled, and

when executing the instruction, the instruction execution processor determines, by accessing the storage, whether or not the instruction is already compiled.

(Supplementary Note 11)

The information processing method according to Supplementary Note 9 or 10, comprising, each time a count of identifiers detected since last compilation by the information processing method reaches a predetermined number, compiling instructions that is not compiled yet among instructions specified by the detected identifiers.

(Supplementary Note 12)

The information processing method according to Supplementary Note 9 or 10, comprising, each time a count of detected identifiers of instructions which are not compiled yet reaches a predetermined number, compiling, at a time, the instructions which are not compiled yet.

(Supplementary Note 13)

The information processing method according to any one of Supplementary Notes 9 to 12, comprising, based on an access through which the instruction execution processor retrieves the instruction from the storage, retrieving an identifier of the instruction being retrieved.

(Supplementary Note 14)

The information processing method according to any one of Supplementary Notes 9 to 12, comprising:

determining whether or not the identifier specified based on the access is an identifier of the instruction that is not compiled yet; and

detecting an identifier having been determined to be the identifier of the instruction that is not compiled yet, as an identifier of the instruction to be compiled by the information processing method.

(Supplementary Note 15)

The information processing method according to any one of Supplementary Notes 9 to 14, comprising:

retrieving, when detecting the identifier, the instruction specified by the identifier, and

compiling the retrieved instruction.

(Supplementary Note 16)

A non-transitory computer-readable storage medium storing a program that causes an information processing device to execute:

detection processing of detecting an access to a storage by an instruction execution processor, the instruction execution processor retrieving an instruction different from a native code from the storage and executing the instruction after interpretation, and to detect an identifier of the instruction based on the detected access; and

compilation processing of compiling the instruction specified by the detected identifier into one or more native codes and write the one or more native codes into the storage,

wherein, in executing the instruction, when the instruction is already compiled, the instruction execution processor retrieves the one or more native codes from the storage, and executes the one or more native codes.

(Supplementary Note 17)

The storage medium according to Supplementary Note 16, wherein

the storage stores information indicating whether or not the instruction is already compiled, and

when executing the instruction, the instruction execution processor determines, by accessing the storage, whether or not the instruction is already compiled.

(Supplementary Note 18)

The storage medium according to Supplementary Note 16 or 17, wherein the compilation processing includes compiling, each time a count of identifiers detected by the detection processing since last compilation by the compilation processing reaches a predetermined number, instructions that is not compiled yet among instructions specified by the detected identifiers.

(Supplementary Note 19)

The storage medium according to Supplementary Note 16 or 17, wherein the compilation processing includes compiling, each time a count of detected identifiers of instructions which are not compiled yet reaches a predetermined number, the instructions which are not compiled yet at a time.

(Supplementary Note 20)

The storage medium according to any one of Supplementary Notes 16 to 19, wherein the detection processing includes retrieving, based on an access through which the instruction execution processor retrieves the instruction from the storage, an identifier of the instruction being retrieved.

(Supplementary Note 21)

The storage medium according to any one of Supplementary Notes 16 to 19, wherein the detection processing includes:

determining whether or not the identifier specified based on the access is an identifier of the instruction that is not compiled yet; and

detecting an identifier having been determined to be the identifier of the instruction that is not compiled yet, as an identifier of the instruction to be compiled by the compilation processing.

(Supplementary Note 22)

The information processing device according to any one of Supplementary Notes 16 to 21, wherein

the detection processing includes retrieving, when detecting the identifier, the instruction specified by the identifier, and

the compilation processing includes compiling the instruction having been retrieved by the detection processing.

In the technology disclosed in JP 4713820 B, each time a method that has not yet been compiled is executed, the instruction execution processing unit needs to transmit the compilation request to the compilation request management unit. Throughput in relation to the execution of instructions by the instruction execution processing unit may be lowered by an amount of load equivalent to processing for transmitting the compilation request.

In the technology disclosed in JP 2013-61810 A as well, the CPU for executing instructions directs the execution of compilation to the CPU for executing compilation. For this reason, in this technology, similarly to the technology disclosed in JP 4713820 B, there exists the problem in that the throughput may be lowered.

In contrast thereto, according to the present invention, throughput when an information processing device processes instructions based on an ISA different from the ISA of native codes is further improved.

1. An information processing device comprising:
a detection circuit configured to detect an access to a storage by an instruction execution processor, the instruction execution processor retrieving an instruction different from a native code from the storage and executing the instruction after interpretation, and to detect an identifier of the instruction based on the detected access; and
a compilation execution circuit configured to compile the instruction specified by the detected identifier into one or more native codes and write the one or more native codes into the storage,
wherein, in executing the instruction, when the instruction is already compiled, the instruction execution processor retrieves the one or more native codes from the storage, and executes the one or more native codes.

2. The information processing device according to claim 1, wherein
the storage stores information indicating whether or not the instruction is already compiled, and
when executing the instruction, the instruction execution processor determines, by accessing the storage, whether or not the instruction is already compiled.

3. The information processing device according to claim 1, wherein, each time a count of identifiers detected by the detection circuit since last compilation by the compilation execution circuit reaches a predetermined number, the compilation execution circuit compiles instructions that is not compiled yet among instructions specified by the detected identifiers.

4. The information processing device according to claim 1, wherein, each time a count of detected identifiers of instructions which are not compiled yet reaches a predetermined number, the compilation execution circuit compiles, at a time, the instructions which are not compiled yet.

5. The information processing device according to claim 1, wherein, based on an access through which the instruction execution processor retrieves the instruction from the storage, the detection circuit retrieves an identifier of the instruction being retrieved.

6. The information processing device according to claim 1, wherein the detection circuit determines whether or not the identifier specified based on the access is an identifier of the instruction that is not compiled yet, and detects an identifier having been determined to be the identifier of the instruction that is not compiled yet, as an identifier of the instruction to be compiled by the compilation execution circuit.

7. The information processing device according to claim 1, wherein
the detection circuit retrieves, when detecting the identifier, the instruction specified by the identifier, and
the compilation execution circuit compiles the instruction having been retrieved by the detection circuit.

8. The information processing device according to claim 1, further comprising:
the instruction execution processor; and
the storage.

9. An information processing method comprising:
detecting an access to a storage by an instruction execution processor, the instruction execution processor retrieving an instruction different from a native code from the storage and executing the instruction after interpretation, and to detect an identifier of the instruction based on the detected access; and
compiling the instruction specified by the detected identifier into one or more native codes and write the one or more native codes into the storage,
wherein, in executing the instruction, when the instruction is already compiled, the instruction execution processor retrieves the one or more native codes from the storage, and executes the one or more native codes.

10. The information processing method according to claim 9, wherein
the storage stores information indicating whether or not the instruction is already compiled, and
when executing the instruction, the instruction execution processor determines, by accessing the storage, whether or not the instruction is already compiled.

11. The information processing method according to claim 9, comprising, each time a count of identifiers detected since last compilation by the information processing method reaches a predetermined number, compiling instructions that is not compiled yet among instructions specified by the detected identifiers.

12. The information processing method according to claim 9, comprising, each time a count of detected identifiers of instructions which are not compiled yet reaches a predetermined number, compiling, at a time, the instructions which are not compiled yet.

13. The information processing method according to claim 9, comprising, based on an access through which the instruction execution processor retrieves the instruction from the storage, retrieving an identifier of the instruction being retrieved.

14. The information processing method according to claim 9, comprising:
determining whether or not the identifier specified based on the access is an identifier of the instruction that is not compiled yet; and
detecting an identifier having been determined to be the identifier of the instruction that is not compiled yet, as an identifier of the instruction to be compiled by the information processing method.

15. A non-transitory computer-readable storage medium storing a program that causes an information processing device to execute:
detection processing of detecting an access to a storage by an instruction execution processor, the instruction execution processor retrieving an instruction different from a native code from the storage and executing the instruction after interpretation, and to detect an identifier of the instruction based on the detected access; and
compilation processing of compiling the instruction specified by the detected identifier into one or more native codes and write the one or more native codes into the storage,
wherein, in executing the instruction, when the instruction is already compiled, the instruction execution processor retrieves the one or more native codes from the storage, and executes the one or more native codes.

16. The storage medium according to claim 15, wherein
the storage stores information indicating whether or not the instruction is already compiled, and
when executing the instruction, the instruction execution processor determines, by accessing the storage, whether or not the instruction is already compiled.

17. The storage medium according to claim 15, wherein the compilation processing includes compiling, each time a count of identifiers detected by the detection processing since last compilation by the compilation processing reaches a predetermined number, instructions that is not compiled yet among instructions specified by the detected identifiers.

18. The storage medium according to claim 15, wherein the compilation processing includes compiling, each time a count of detected identifiers of instructions which are not compiled yet reaches a predetermined number, the instructions which are not compiled yet at a time.

19. The storage medium according to claim 15, wherein the detection processing includes retrieving, based on an access through which the instruction execution processor retrieves the instruction from the storage, an identifier of the instruction being retrieved.

20. The storage medium according to claim 15, wherein the detection processing includes:
determining whether or not the identifier specified based on the access is an identifier of the instruction that is not compiled yet; and
detecting an identifier having been determined to be the identifier of the instruction that is not compiled yet, as an identifier of the instruction to be compiled by the compilation processing.
